(19) United States
(12) Patent Application Publication
(10) Pub. No.: US 2025/0167961 A1
(43) Pub. Date: May 22, 2025

(54) ENHANCED REDUCED CAPABILITY USER EQUIPMENT

(71) Applicant: Apple Inc., Cupertino, CA (US)

(72) Inventors: Hong He, San Jose, CA (US); Chunxuan Ye, San Diego, CA (US); Dawei Zhang, Saratoga, CA (US); Weidong Yang, San Diego, CA (US); Yushu Zhang, Beijing (CN); Wei Zeng, Saratoga, CA (US); Oghenekome Oteri, San Diego, CA (US); Chunhai Yao, Beijing (CN); Sigen Ye, Whitehouse Station, NJ (US); Haitong Sun, Cupertino, CA (US)

(21) Appl. No.: 18/836,718

(22) PCT Filed: Feb. 12, 2022
(86) PCT No.: PCT/CN2022/076117

§ 371 Date: Aug. 7, 2024

(51) Int. Cl. H04L 5/00; H04W 24/08

(52) U.S. Cl. CPC H04L 5/0053; H04L 5/0044; H04W 24/08

(57) ABSTRACT

Disclosed are methods, systems, and computer-readable medium to perform operations including: identifying one or more instances of a control resource set (“CORESET”); monitoring a physical downlink control channel (“PDCCH”) candidate to detect a physical downlink control channel using the one or more instances of the CORESET; and receiving, based on the detected PDCCH, data scheduled by the PDCCH.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

To reduce complexity, reduce power usage, reduce data rate reduce data requirements, or a combination of these, an enhanced reduced capability user equipment can have one or more of the following features. The eRedCap can have repeated control resource sets (“CORESETs”), an increased set of CORESET symbols, an enhanced CORESET (“eCORESET”), or a combination of two or more of these. An eRedCap device can use an index to determine a location of an eCORESET, e.g., in the frequency-domain, use a random access channel occasion (“RO”) association pattern period, two or more ROs in a half-frame, or a combination of two or more of these.

In accordance with one aspect of the present disclosure, identifying one or more instances of a control resource set (“CORESET”); monitoring a physical downlink control channel (“PDCCH”) candidate to detect a physical downlink control channel using the one or more instances of the CORESET; and receiving, based on the detected PDCCH, data scheduled by the PDCCH.

In accordance with one aspect of the present disclosure, determining, by a first device, that a second device with which the first device will communicate is an enhanced-reduced capability device; in response to determining that the second device is an enhanced-reduced capability device, selecting a physical downlink control channel for the communication with the enhanced-reduced capability device; determining a control resource set that is used for the physical downlink control channel communication; configuring one or more instances of the control resource set; and transmitting, using the control resource set, the physical downlink control channel.

In accordance with one aspect of the present disclosure, identifying a configuration of a control resource set (CORESET) that includes more than three symbols in a time domain; monitoring a physical downlink control channel (PDCCH) candidate to detect a physical downlink control channel using the configuration of the CORESET; and receiving, based on the detected PDCCH, data scheduled by the PDCCH.

In accordance with one aspect of the present disclosure, receiving an index that indicates a frequency-domain location of an enhanced control resource set (CORESET); determining, using the index, an offset value for the frequency-domain location of the enhanced control resource set; and determining, using the offset value, the frequency-domain location of the enhanced control resource set in the frequency-domain.

In accordance with one aspect of the present disclosure, identifying two or more physical random access channel (“PRACH”) occasions according to an association pattern period that includes one of i) at least 32 physical random access channel association periods for a configuration period of 10 milliseconds, ii) at least 16 physical random access channel association periods for a configuration period of 20 milliseconds, iii) at least 8 physical random access channel association periods for a configuration period of 40 milliseconds, iv) at least 4 physical random access channel association periods for a configuration period of 80 milliseconds, or v) at least 2 physical random access channel association periods for a configuration period of 160 milliseconds; and transmitting a PRACH message according to the two or more physical random access channel occasions.

In accordance with one aspect of the present disclosure, identifying, in a half-frame, two or more physical random access channel (“PRACH”) occasions in corresponding subframes, which subframes are separated in time; and transmitting a PRACH message according to the two or more physical random access channel occasions.

A system, e.g., a base station, an apparatus comprising one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of the described embodiments.

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, identifying the one or more instances of the CORESET can include identifying a first instance of the CORESET with a first mapping of a control channel element (“CCE”) to a resource element group (“REG”) mapping configured by Radio Resource Control (“RRC”) signaling; and identifying a second different instance of the CORESET with a second mapping of a CCE-to-REG mapping configured by RRC signaling. Monitoring the PDCCH candidate can include monitoring the PDCCH candidate using a union of the first instance and the second different instance of the CORESET.

In some implementations, identifying the one or more instances of the CORESET can include identifying one or more intra-slot instances of the CORESET that are configured by RRC signaling. Identifying the one or more instances of the CORESET can include identifying one or more inter-slot instances of the CORESET that are configured by RRC signaling.

In some implementations, the method can include receiving a value K of offset parameter that is configured for a first instance of the CORESET by Radio Resource Control (RRC) signaling; and determining a first symbol of a second instance of the CORESET after K symbols from a last symbol of the first instance. The one or more instances of the CORESET can include two or more instances of the CORESET including the first instance and the second instance. The method can include receiving a value K of offset parameter that is configured for a first instance of the CORESET by Radio Resource Control (RRC) signaling; and determining a first symbol of a second instance of the CORESET after K slots from a first symbol of the first instance. The one or more instances of the CORESET can include two or more instances of the CORESET including the first instance and the second instance.

In some implementations, identifying the one or more instances of the CORESET can include identifying the one or more instances of the CORESET configured with a 30 kHz subcarrier spacing and a frequency bandwidth (BW) that is less than or equal to 5 MHz. The CORESET can include a CORESET 0. The CORESET can include a number of consecutive resource blocks (RBs) in frequency domain that is less than ten. The CORESET can include a number of consecutive symbols that is greater than three.

In some implementations, a CORESET configuration can include a set of parameters that includes: a number of consecutive resource blocks (“RBs”); a number of consecutive symbols; and a number of repetitions. The number of RBs can be 8. The number of consecutive symbols can be selected from a group comprising 3, 6 or 12. The number of repetitions can be 2 or 4.

In some implementations, the method can include determining one or more configuration values for the control resource set using a master information block, a physical broadcast channel, or both. Determining the one or more configuration values can include determining the one or more configuration values using an information element from the master information block, at least one bit from a payload of the physical broadcast channel, or both.

In some implementations, the method can include determining a number of repetitions of the control resource set to send. Determining the number of repetitions can include determining a fixed number of repetitions of the control resource set to send. Determining the number of repetitions can include determining, using a radio resource control signal, the number of repetitions of the control resource set to send.

In some implementations, the method can include signaling one or more configuration values for the control resource set using a master information block, a physical broadcast channel, or both. Signaling the one or more configuration values can include signaling the one or more configuration values using an information element from the master information block, at least one bit from a payload of the physical broadcast channel, or both. Signaling the one or more configuration values for control resource set can include signaling one or more of a number of consecutive resource blocks, a number of consecutive symbols, or a number of instances of the control resource set.

In some implementations, the configuration of the control resource set can include six symbols in the time domain. The configuration of the control resource set can include twelve symbols in the time domain. The control resource set can include a control channel element to resource element group mapping, the resource element group having a bundle size that is the same as a number of symbols configured for the control resource set. The control resource set can include a control channel element to resource element group mapping, the resource element group having a bundle size of either six or twelve.

In some implementations, the method can include configuring, using the control resource set, a user equipment to monitor PDCCH candidates. Identifying the configuration of the control resource set can include identifying the configuration of the control resource configured with a 30 kHz subcarrier spacing and a frequency bandwidth (BW) that is less than or equal to 5 MHz.

In some implementations, the configuration of the control resource set can include i) a number of consecutive resource blocks equal to eight, a number of consecutive symbols equal to six, and a number of repetitions is one, ii) the number of consecutive resource blocks equal to four, the number of consecutive symbols equal to twelve, and the number of repetitions is one, iii) the number of consecutive resource blocks equal to eight, the number of consecutive symbols equal to twelve, and the number of repetitions is one, or iv) the number of consecutive resource blocks equal to six, the number of consecutive symbols equal to twelve, and the number of repetitions is two.

In some implementations, the method can include receiving, across a frequency bandwidth that is less than 5 MHz, the enhanced control resource set. Receiving the index can include receiving the index that indicates the frequency-domain location of the enhanced control resource set with respect to a smallest resource block or a largest resource block of a synchronization signal/physical broadcast channel block on a corresponding physical broadcast channel.

In some implementations, the method can include searching, by an enhanced-reduced capability user equipment, for a synchronization signal using the synchronization signal/physical broadcast channel block that can be used by a non-enhanced-reduced capability user equipment. Receiving the index can include receiving the index that indicates the frequency-domain location of the enhanced control resource set with respect to a smallest resource block or a largest resource block of a non-enhanced control resource set. Determining the offset value can include determining the offset value for the enhanced control resource set using the index for one of a plurality of configurations that each include at least one of a number of consecutive resource blocks, a number of consecutive symbols, or a number of repetitions.

In some implementations, receiving the index can include: receiving a master information block, a physical broadcast channel signal, or both; and determining, using one or more bits from the master information block or the physical broadcast channel signal or both, the index. Determining the index can include determining the index using an information element from the master information block, at least one bit from a payload of the physical broadcast channel, or both.

In some implementations, the method can include generating the PRACH message according to the two or more random access channel occasions within the association pattern period. Identifying the two or more PRACH occasions can include receiving, from a base station, configuration data for the PRACH occasions. The base station can have created the configuration data when configuring the PRACH occasions.

In some implementations, the association pattern period can include, for a 10 millisecond configuration period, {1, 2, 4, 8, 16, 32, 64, 128}. The association pattern period can include, for a 20 millisecond configuration period, {1, 2, 4, 8, 16, 32, 64}. The association pattern period can include, for a 40 millisecond configuration period, {1, 2, 4, 8, 16, 32}. The association pattern period can include, for a 80 millisecond configuration period, {1, 2, 4, 8, 16}. The association pattern period can include, for a 160 millisecond configuration period, {1, 2, 4, 8}.

In some implementations, the method can include generating the PRACH message according to the two or more random access channel occasions within an association pattern period. Identifying the two or more PRACH occasions can include receiving, from a base station, configuration data for the PRACH occasions. The base station can have created the configuration data when configuring the PRACH occasions. Identifying the two or more random access channel occasions can include identifying, in a half-frame, two random access channel occasions that are shifted in time.

In some implementations, a value of a shift between the two random access channel occasions can be based on two subframe indices of two predetermined physical random access channel slots in a frame that includes the half-frame and a number of newly added random access channel subframes. The two subframe indices can be one and six. Identifying the two or more random access channel occasions can include identifying, in a half-frame, two random access channel occasions that are consecutive in time.

In some implementations, the method can include determining, using predetermined configuration stored in memory, a number of the two or more random access channel occasions included in the half-frame. The method can include determining, using configuration from a received system information block, a number of the two or more random access channel occasions included in the half-frame. Identifying the two or more random access channel occasions can include identifying, using i) a frequency that is less than or equal to 5 MHz and ii) a 15 kHz subcarrier spacing or a 30 kHz subcarrier spacing, the two or more random access channel occasions.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network 100, in accordance with some embodiments.

FIGS. 2A-B to 5 illustrate example flowcharts of example methods, in accordance with some embodiments.

FIGS. 6A-B depict examples of repeated instances of a CORESET.

FIG. 7 depicts an example CORESET configuration.

FIG. 8 depicts an example environment in which an eCORESET is offset from a reference.

FIG. 9 depicts an example of an environment with two different association periods.

FIG. 10 depicts an example environment that includes one or more additional RACH subframes.

FIG. 11 illustrates a user equipment (UE), in accordance with some embodiments.

FIG. 12 illustrates an access node, in accordance with some embodiments.

### DETAILED DESCRIPTION

User equipment (“UE”), such as new radio (“NR”) reduced capability (“RedCap”) devices for 3GPP Release 17, can include industrial sensors, video surveillance devices, and wearables, to name a few examples. The user equipment can require low complexity, low power consumption, low data rate requirements, or a combination of these. In some instances, a Release 17 RedCap UE may typically operate using a reduced channel bandwidth of approximately 20 MHz within frequency range 1 (“FR1”), defined as sub-6 GHz frequency bands for NR. The reduced channel bandwidth operation allows for a reduction in cost of a RedCap UE compared to a regular UE.

Newer devices targeting a further reduction in NR RedCap UE complexity, cost, energy consumption and data rates are intended to further expand the market for RedCap use cases. or instance, an NR RedCap device, e.g., an enhanced RedCap (“eRedCap”) device for 3GPP Release 18, can have a maximum supported peak data rate of 10 Mbps, not overlap with existing low-power wide-area (“LPWA”) solutions, or both.

As a result, NR eRedCap devices can have a further bandwidth reduction to 5 MHz in frequency range 1 (“FR1”), e.g., be limited to frequencies of 5 MHz or less, a reduced peak data rate in FR1, or both. In some examples, NR eRedCap devices can have a relaxed processing timeline for a physical downlink shared channel (“PDSCH”), a physical uplink shared channel (“PUSCH”), channel state information (“CSI”), or a combination of two or more of these.

To enable an eRedCap device to communicate with other devices, such as a base station, while satisfying the requirements for an eRedCap, the eRedCap can have repeated control resource sets (“CORESETs”), an increased set of CORESET symbols, an enhanced CORESET (“eCORESET”), or a combination of two or more of these. An eRedCap device can use an index to determine a location of an eCORESET, e.g., in the frequency-domain, use a random access channel occasion (“RO”) association pattern period, two or more ROs in a half-frame, or a combination of two or more of these.

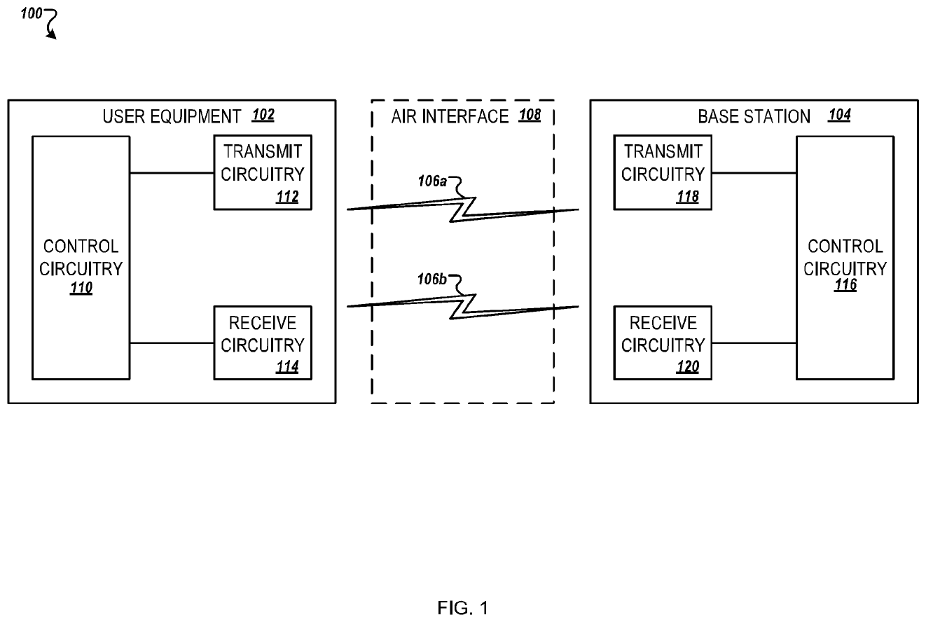

FIG. 1 illustrates a wireless network 100, in accordance with some embodiments. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

For purposes of convenience and without limitation, the wireless network 100 is described in the context of Long Term Evolution (LTE) and Fifth Generation (5G) New Radio (NR) communication standards as defined by the Third Generation Partnership Project (3GPP) technical specifications. More specifically, the wireless network 100 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless network 100 may also be a Standalone (SA) network that incorporates only NR. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, printers, machine-type devices such as smart meters or specialized devices for healthcare monitoring, remote security surveillance systems, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some embodiments, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may be adapted to perform operations associated with selection of codecs for communication and to adaption of codecs for wireless communications as part of system congestion control. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry, including communications using codecs as described herein.

The control circuitry 110 can perform various operations described in this specification. For instance, the control circuitry 110 can identify one or more instances of a CORESET, determine a frequency-domain location of an eCORESET, identify two or more ROs, or a combination of these.

The transmit circuitry 112 can perform various operations described in this specification. For instance, the transmit circuitry 112 can transmit a PRACH message.

The receive circuitry 114 can perform various operations described in this specification. For example, the receive circuitry 114 can monitor a PDCCH candidate, receive data, receive an index, or a combination of these.

In various embodiments, aspects of the transmit circuitry 112, receive circuitry 114, and control circuitry 110 may be integrated in various ways to implement the circuitry described herein. The control circuitry 110 may be adapted or configured to perform various operations such as those described elsewhere in this disclosure related to a UE. The transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108. Similarly, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In embodiments, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which comprises a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108.

The control circuitry 116, the transmit circuitry 118, the receive circuitry 120, or a combination of these can perform one or more operations described in this specification. For instance, the control circuitry 116 can determine whether a UE is an eRedCap UE, select a PDCCH, determine a CORESET, or a combination of these. The transmit circuitry 118 can transmit a PDCCH.

The control circuitry 116 may be adapted to perform operations for analyzing and selecting codecs, managing congestion control and bandwidth limitation communications from a base station, determining whether a base station is codec aware, and communicating with a codec-aware base station to manage codec selection for various communication operations described herein. The transmit circuitry 118 and receive circuitry 120 may be adapted to transmit and receive data, respectively, to any UE connected to the base station 104 using data generated with various codecs described herein. The transmit circuitry 118 may transmit downlink physical channels comprised of a plurality of downlink subframes. The receive circuitry 120 may receive a plurality of uplink physical channels from various UEs, including the UE 102.

In this example, the one or more channels 106A, 106B are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UE 102 may directly exchange communication data via a ProSe interface. The ProSe interface may alternatively be referred to as a SL interface and may comprise one or more logical channels, including but not limited to a PSCCH, a PSSCH, a PSDCH, and a PSBCH.

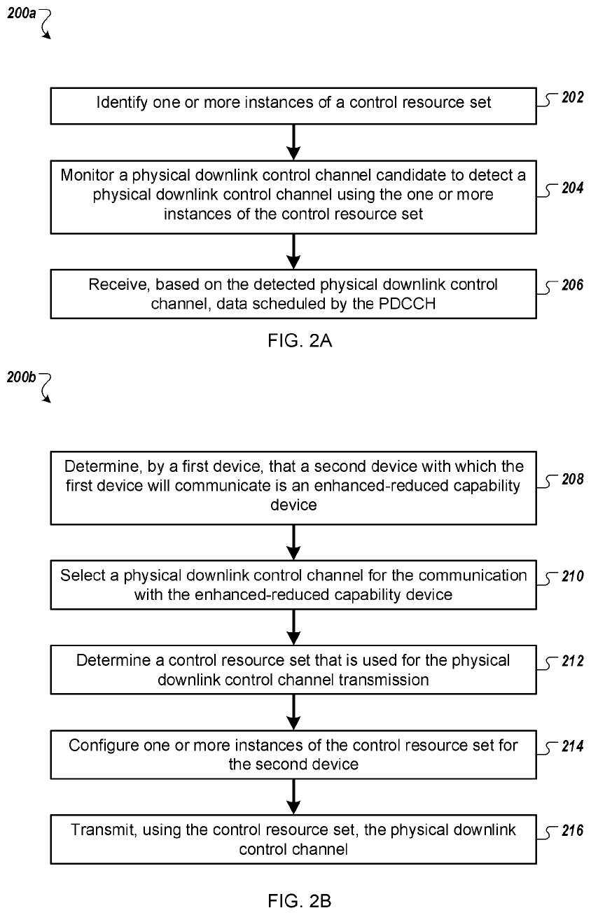

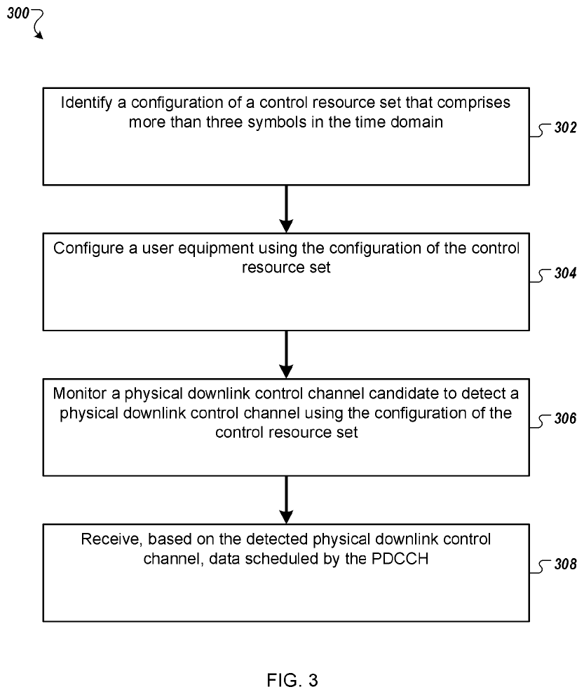

FIG. 2A illustrates a flowchart of an example method 200a, according to some implementations. For clarity of presentation, the description that follows generally describes method 200a in the context of the other figures in this description. For example, method 200a can be performed by a user equipment of FIG. 1. It will be understood that method 200a can be performed, for example, by any suitable system, environment, software, hardware, or a combination of systems, environments, software, and hardware, as appropriate. In some implementations, various steps of method 200a can be run in parallel, in combination, in loops, or in any order.

A user equipment identifies one or more instances of a control resource set (202). For instance, the user equipment can identifies some of the instances of the control resource set (“CORESET”) using a 30 kHz subcarrier spacing and a frequency that is less than or equal to 5 MHz

The user equipment monitors a physical downlink control channel candidate to detect a physical downlink control channel using the one or more instances of the control resource set (204). For instance, the user equipment searches one or more of the CORESETS to monitor the physical downlink control channel (“PDCCH”) candidate.

The user equipment receives, based on the detected physical downlink control channel, data scheduled by the PDCCH (206). For example, the user equipment receives downlink data from a base station that is scheduled by the PDCCH.

FIG. 2B illustrates a flowchart of an example method 200b, according to some implementations. For clarity of presentation, the description that follows generally describes method 200b in the context of the other figures in this description. For example, method 200b can be performed by base station 104 of FIG. 1. It will be understood that method 200b can be performed, for example, by any suitable system, environment, software, hardware, or a combination of systems, environments, software, and hardware, as appropriate. In some implementations, various steps of method 200b can be run in parallel, in combination, in loops, or in any order.

A base station, e.g., a first device, determines that a second device with which the first device will communicate is an enhanced-reduced capability device (208).

The base station selects a physical downlink control channel for the communication with the enhanced-reduced capability device (210). The base station can select the PDCCH in response to determining that the second device is an enhanced-reduced capability device.

The base station determines a control resource set that is used for the physical downlink control channel transmission (212). For instance, the base station can determine a CORESET with which the second device, e.g., an eRedCap, can be configured for PDCCH transmission. In some instances, the base station can determine the CORESET in response to determining that the second device is an enhanced-reduced capability device.

The base station configures one or more instances of the control resource set for the second device (214). The second device can be an eRedCap UE. The base station can configure one or more instances of the CORESET with a 30 kHz subcarrier spacing and a frequency bandwidth that is less than or equal to 5 MHz

The base station transmits, using the control resource set, the physical downlink control channel (216). The base station can transmit the PDCCH to schedule a data transmission with the second device. For example, the base station can send downlink data to the eRedCap which downlink data is scheduled by the PDCCH.

FIG. 3 illustrates a flowchart of an example method 300, according to some implementations. For clarity of presentation, the description that follows generally describes method 300 in the context of the other figures in this description. For example, method 300 can be performed by the user equipment 102, or a baseband processor, of FIG. 1. It will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

A user equipment identifies a configuration of a control resource set that comprises more than three symbols in the time domain (302). The user equipment can receive, as part of the configuration, PDCCH transmitted on the CORESET from a base station.

In some examples, the base station configures the CORESET that comprises more than three symbols in the time domain to the user equipment. The base station can configure the CORESET in response to determining that the user equipment is an enhanced-reduced capability user equipment. The base station can then transmit, on the CORESET, the PDCCH based on the configuration.

The user equipment configures itself using the configuration of the control resource set (304). For instance, the user equipment or the baseband processor or both can adjust one or more settings of the user equipment, the baseband processor, or both, using the identified control resource set configuration.

The user equipment monitors a physical downlink control channel candidate to detect a physical downlink control channel using the configuration of the control resource set (306). For instance, the user equipment searches one or more of the CORESETS to monitor the physical downlink control channel (“PDCCH”) candidate.

The user equipment receives, based on the detected physical downlink control channel, data scheduled by the PDCCH (308). For example, the user equipment receives downlink data from a base station that is scheduled by the PDCCH.

FIG. 4 illustrates a flowchart of an example method 400, according to some implementations. For clarity of presentation, the description that follows generally describes method 400 in the context of the other figures in this description. For example, method 400 can be performed by the user equipment 102, or a baseband processor, of FIG. 1. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

A user equipment receives an index that indicates a frequency-domain location of an enhanced control resource set (402). The user equipment can receive the index in one or more messages. For instance, the user equipment can receive one or more bits for the index in a master information block, a PBCH, or both. The index can be from a reference, e.g., described in more detail below with reference to example 4.

The user equipment determines, using the index, an offset for the frequency-domain location of the enhanced control resource set (404). For instance, the user equipment determines the location for the enhanced control resource set in the frequency-domain with respect to the reference.

The user equipment decodes, using the offset, the enhanced control resource set (406).

FIG. 5 illustrates a flowchart of an example method 500, according to some implementations. For clarity of presentation, the description that follows generally describes method 500 in the context of the other figures in this description. For example, method 500 can be performed by the user equipment 102, or a baseband processor, of FIG. 1. In some examples, corresponding steps can be performed by the base station of FIG. 1, e.g., sending instead of receiving. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

A user equipment identifies a number of two or more physical random access channel occasions included in a half-frame or an association pattern period (502). For instance, the user equipment can use predetermined configuration data stored in memory, e.g., hard coded configuration data, configuration data from a received system information block, or both, to determine the number of the two or more physical random access channel occasions included in the half-frame. The user equipment can receive the system information block from a base station.

The association pattern period can be any of i) at least 32 physical random access channel association periods for a configuration period of 10 milliseconds, ii) at least 16 physical random access channel association periods for a configuration period of 20 milliseconds, iii) at least 8 physical random access channel association periods for a configuration period of 40 milliseconds, iv) at least 4 physical random access channel association periods for a configuration period of 80 milliseconds, or v) at least 2 physical random access channel association periods for a configuration period of 160 milliseconds.

The user equipment can generate a physical random access channel (PRACH) message according to the two or more random access channel occasions (ROs) (504). The user equipment can generate the PRACH message as described below with reference to example 5. The two or more ROs can be included in the half-frame or within the association pattern period.

In some examples, the user equipment identifies the two or more random access channel occasions in a half-frame. The ROs can be in corresponding subframes that are separated in time.

The user equipment transmits the physical random access channel message according to the two or more physical random access channel occasions (506). For instance, the user equipment can send data or a random access preamble to a base station.

### Examples

In the following sections, further exemplary embodiments are provided.

To support the reduced bandwidth and peak data rate requirements of eRedCap UEs, several issues may need to be addressed, such as, for example, discrepancies in the required bandwidth required for various initial access procedures versus the reduced 5 MHz frequency bandwidth within which eRedCap UEs may be required to operate. Table 1, below, indicates the maximum transmission bandwidth configuration for the available subcarrier spacing (“SCS”) frequencies for 5 MHz transmissions. As shown in Table 1, for 5 MHz transmissions in FR1, a base station, a user equipment, or both, can use either 15 kHz or 30 kHz SCS, e.g., during transmissions between the base station and the user equipment. At 15 kHz SCS, a UE may communicate with up to 25 resource blocks while operating in 5 MHz frequency, while at 30 kHz SCS, a UE may communicate with up to 11 resource blocks while operating in 5 MHz frequency.

TABLE 1
Maximum transmission bandwidth configuration

| | 5 MHz |
|---|---|
| Subcarrier Spacing (kHz) | N_{RB} |
| 15 | 25 |
| 30 | 11 |

In contrast, table 2, below, shows the required bandwidth for channels of initial access procedure. In particular, Table 2 summarizes the required bandwidth (“BW”) for an synchronization signal/physical broadcast channel (“SSB”) block; control resource set 0 (“CORESET #0”), e.g., that transmits physical downlink control channel (“PDCCH”) for system information block 1 (“SIB1”) scheduling; and physical random access channel (“PRACH”) with 15 kHz and 30 kHz SCS for initial access procedure. The initial access procedure can include cell search and system information acquisition.

TABLE 2
Required bandwidth for channels of Initial Access Procedure

| | Synchronization | | Physical Random |
|---|---|---|---|
| | Signal Block | CORESET#0 | Access Channel |
| 15 kHz SCS | 3.6 MHz | 24 RBs @ 4.32 MHz | L839: 6RB @ 15 kHz SCS |
| | | 48 RBs @ 8.64 MHz | L139: 12RB @ 2.16 MHz |
| | | 96 RBs @ 17.28 MHz | |
| 30 kHz SCS | 7.2 MHz | 24 RBs @ 8.64 MHz | L839: 3RB @ 30 kHz SCS |
| | | 48 RBs @ 17.28 MHz | L139: 12RB @ 4.32 MHz |

As indicated in Table 2, there are two potential problems with these frequencies for use with eRedCap devices, e.g., when a base station communicates with an eRedCap device. Specifically, for SSB reception, a minimum 7.2 MHz bandwidth is desirable to support 30 kHz SCS SSB, which 7.2 MHz minimum bandwidth is greater than the 5 MHz target of eRedCap UEs. Accordingly, while an eRedCap UE may be able to support SSB reception at 15 kHz SCS due to the SSB bandwidth of 3.6 MHz, the eRedCap UE may have difficulty supporting SSB reception at 30 kHz SCS due to the SSB bandwidth of 7.2 MHz.

For CORESET #0 for FR1, e.g., for Type0-PDCCH, an eRedCap device that is limited to 5 MHz bandwidth (translating to 11 PRBs at 30 kHz or 25 PRBs at 15 kHz) may be unable to support all possible CORESET #0 configurations. For example, CORESET #0 for Type0-PDCCH can be configured as large as 17.28 MHz in the frequency domain, e.g., for 96 PRBs for 15 kHz SCS and 48 PRBs for 30 kHz SCS, and up to 3 orthogonal frequency division multiplexing (“OFDM”) symbols. In reference to Table 2, an eRedCap UE may only be able to support a CORESET #0 configuration of 24 PRBs at 4.32 MHz in 15 kHz SCS operation while being unable to support other CORESET #0 configurations of 48 PRBs at 8.64 MHz or 96 PRBs at 17.28 MHz in 15 kHz SCS operation due to the eRedCap UE's potential limitation of 5 MHz bandwidth. As seen in Table 2, an eRedCap device might not have any CORESET #0 configurations with 30 kHz SCS that can be used because the two options exceed the eRedCap UE's potential maximum 5 MHz bandwidth, which is restricted to a maximum of 11 PRBs at 30 kHz SCS.

A CORESET can use one or more CCE to indicate PDCCH candidates. The number of CCEs used is indicated by an aggregation level (“AL”). For instance, a CORESET can have an AL of 1, 2, 4, 8, or 16, to name a few examples. Since the aggregation level indicates the number of CCE used in a frequency domain and correspond to a number of physical resources blocks required to transmit the corresponding CORESET, when a CORESET has an AL of 16, it requires 16 PRBs in the frequency domain, e.g., in a symbol, which is greater than the maximum of 11 PRBs for an eRedCap UE with a 30 kHz SCS.

Example 1 includes identifying one or more instances of a control resource set (“CORESET”); monitoring a physical downlink control channel (“PDCCH”) candidate to detect a physical downlink control channel using the one or more instances of the CORESET; and receiving, based on the detected PDCCH, data scheduled by the PDCCH.

Example 2 includes determining, by a first device, that a second device with which the first device will communicate is an enhanced-reduced capability device; in response to determining that the second device is an enhanced-reduced capability device, selecting a physical downlink control channel for the communication with the enhanced-reduced capability device; determining a control resource set that is used for the physical downlink control channel communication; configuring one or more instances of the control resource set; and transmitting, using the control resource set, the physical downlink control channel.

To enable a device to send, receive, or either, a CORESET with a eRedCap UE, the device can use CORESET repetition in the time domain. The device can be either a base station, e.g., sending the PDCCH on the CORESET, or the eRedCap UE, e.g., monitoring the PDCCH on the CORESET. This can enable the device to communicate a CORESET that has 16 or more CCEs to the eRedCap UE even though the eRedCap UE can only receive a maximum of 11 PRBs at 30 kHz. The device can send one or more instances of the CORESET in different slots, different symbols, or a combination of both. Each of the instances has 11 or fewer PRBs, which satisfies the maximum of 11 PRBs for an eRedCap UE with a 30 kHz SCS.

For instance, the device can use intra-slot or inter-slot CORESET repetition in time domain. For intra-slot CORESET repetition, the device can use a configured CORSET resource that is repeated at different symbols, e.g., a predetermined number of symbols, in the time domain. A first CORESET resource can be transmitted in a first symbol. Then, another instance of the CORESET resource can be transmitted K symbols after the first symbol. Alternatively, the repeated instance transmission of the CORESET resource can be repeated after K symbols from the last symbol in which the configured CORESET was transmitted.

For inter-slot CORESET repetition, a device can use a configured CORSET resource that is repeated after a predetermined number of slots from a starting slot. For instance, a first CORESET resource can be transmitted in a symbol of a first slot. Then, another instance of the CORESET resource can be transmitted in a symbol that is K slots from the first slot. The instance transmission of the CORESET resource can be repeated after K slots from the last slot in which the configured CORESET was transmitted.

The predetermined number, e.g., of slots or symbols, can be any appropriate number. For instance, the predetermined number K value can be hard-encoded, e.g., based on a 3GPP specification. The predetermined number K can be zero. In some examples, the predetermined number K value can be configured by radio resource control (“RRC”) signaling, e.g., as part of CORESET configuration. The predetermined number K can be explicitly or implicitly configured.

The number of repetitions R can be configured by RRC. For instance, the number of repetitions R can be explicitly configured by RRC.

In some examples, a control channel element (“CCE”) to resource element group (“REG”) mapping can be performed independently for a CORESET and each of its associated repetitions.

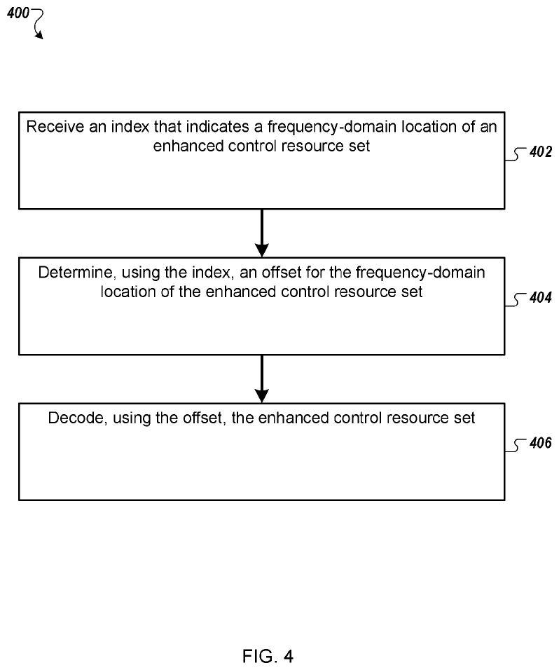

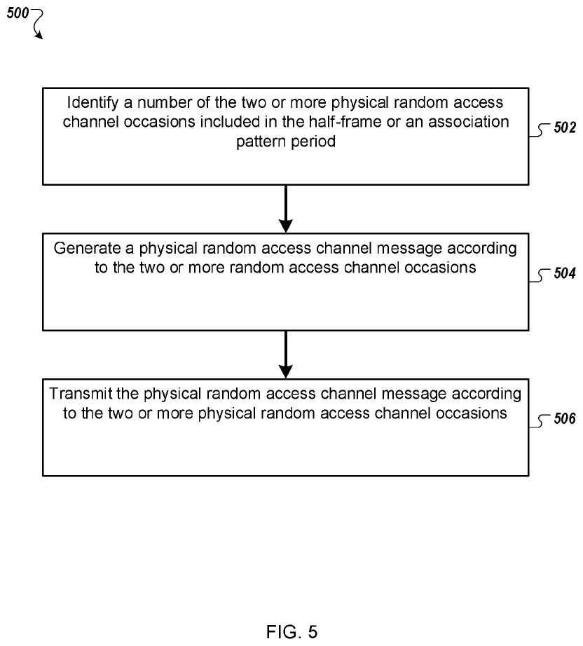

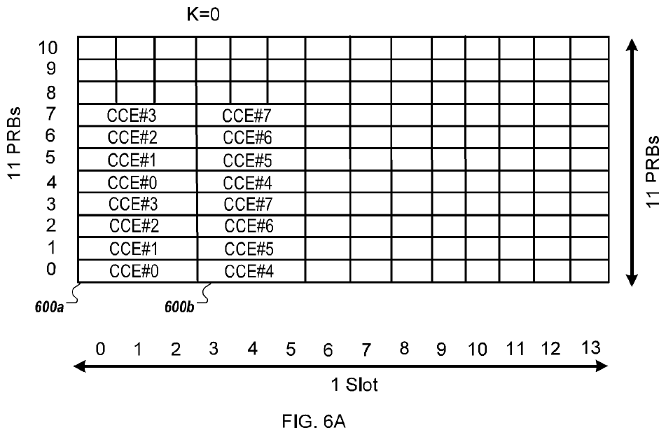

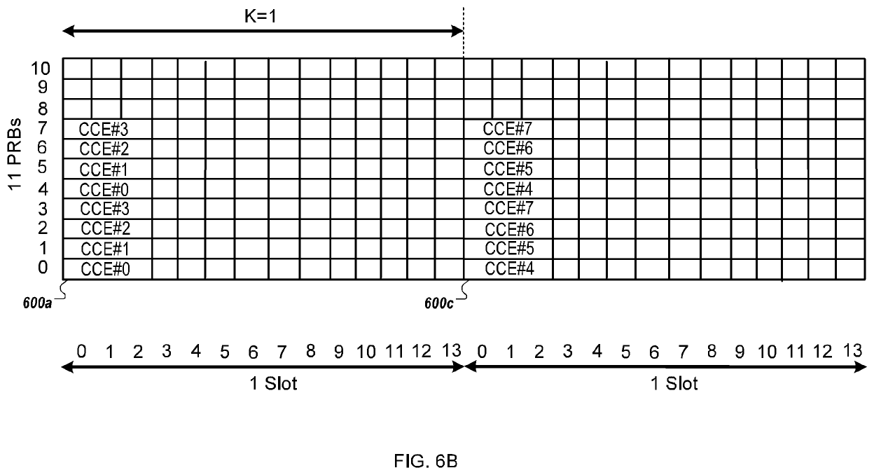

FIGS. 6A-B depict examples of repeated instances of a CORESET 600a-c. The repeated instances of the CORESET can support aggregation level (“AL”) 8 for PDCCH transmission, e.g., as shown by the total number of PRBs in the frequency domain being 8 at indexes 0 through 7. The instances of the CORESET can include an initial CORESET 600a. The instances of the CORESET can include a repeated CORESET 600b-c. As shown in FIG. 6A, the repeated CORESET can be an intra-slot CORESET 600b, repeated after a predetermined number of symbols K from the last symbol of the initial or configured CORESET 600a. In some instances, K may equal zero, as depicted in the illustrated example in FIG. 6A. In any event, for intra-slot CORESET repetition, the repeated CORESET 600b is transmitted in the same slot as the initial CORESET 600a based on the K value provided.

Alternatively or additionally, the repeated CORESET can be an inter-slot CORESET 600c, repeated after a predetermined number of slots K from the first symbol of the initial or configured CORESET 600a. As shown in FIG. 6B, the repeated CORESET 600c is transmitted in a different slot from the configured CORESET 600a, where the slot it is transmitted in is based on the K value. In the illustrated example of FIG. 6B, the repeated CORESET 600c is transmitted in the following slot after the configured CORESET 600a since K=1.

In FIGS. 6A-B, the CCEs can be numbered across the CORESETs, first indexed in an ascending order of physical resource block (“PRB”) index within a CORESET and then indexed in an ascending order of the symbol index in time domain.

For a given aggregation level, an eRedCap user equipment can perform the PDCCH candidate searching across the aggregated CORESET instances, e.g., repetitions. If necessary, the eRedCap can perform PDCCH candidate searching across the CORESETS repetitions, e.g., the repeated instances of the CORESET 600b-c.

Example 3 includes identifying a configuration of a control resource set (CORESET) that comprises more than three symbols in a time domain; monitoring a physical downlink control channel (PDCCH) candidate to detect a physical downlink control channel using the configuration of the CORESET; and receiving, based on the detected PDCCH, data scheduled by the PDCCH.

In some implementations, the CORESET can have an increased number of symbols compared to legacy CORESET configurations, which are limited to three or fewer symbols. For instance, the CORESET, e.g., an eCORESET, can have a number of symbols N_{symb}^{CORESET} greater than 3. In some examples, the number of symbols N_{symb}^{CORESET} can be six. In some examples, the number of symbols N_{symb}^{CORESET} can be twelve. By increasing the number of symbols included in a CORESET, a device can communicate a CORESET with an eRedCap UE that is limited by a maximum of 11 PRBs in the frequency domain for 30 kHz SCS. For instance, a device can use an increased number of symbols to communicate the eCORESET compared to a legacy CORESET, with each symbol in the eCORESET having fewer PRBs than the symbols of a legacy CORESET.

Resource element groups (“REGs”) within an eCORESET can be numbered in increasing order in a time-first manner. For instance, the number can start with 0 for a first OFDM symbol and the lowest-numbered resource block in the eCORESET.

A resource element group (“REG”) bundle size L can be used to support interleaved, non-interleaved, or both, CCE-to-REG mapping. The bundle size L can be 6. In some examples, the bundle size L is equal to N_{symb}^{CORESET}, e.g., when N_{symb}^{CORESET} is either six or twelve.

In some implementations, intra-slot or inter-slot repetition can be supported, e.g., as described above with reference to examples 1 and 2. For instance, intra-slot or inter-slot repetition can be supported at least for 6-symbol eCORESET configuration for AL 16 PDCCH transmission.

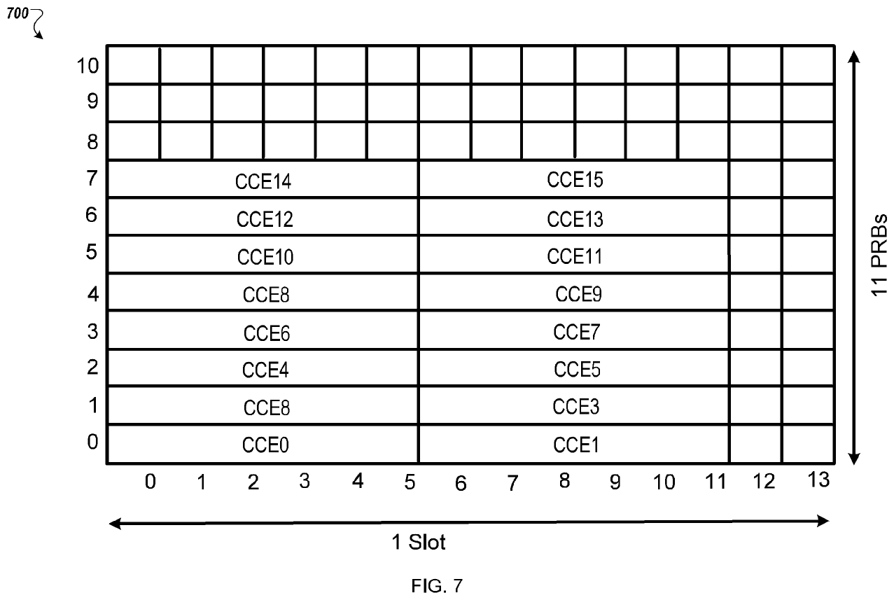

FIG. 7 depicts an example CORESET configuration 700. The CORESET configuration 700 can be for Common Search Space (“CSS”) supporting aggregation level 16. The CORESET configuration 700 has a number of symbols N_{symb}^{CORESET} equal to twelve. The CORESET configuration 700 has a bundle size L equal to six, e.g., for an non-interleaved CCE-to-REG mapping.

In the CORESET configuration 700, symbols 12 and 13 can be reserved for uplink transmission, e.g., hybrid automatic repeat request acknowledgement (“HARQ-ACK”) over physical uplink control channel (“PUCCH”).

In some implementations, a device can use one or more configuration values for a CORESET, e.g., an enhanced CORESET (“eCORESET”). The eCORESET can be for the Type0-PDCCH CSS set.

The configuration values can include a number of consecutive resource blocks N_{RB}^{CORESET}. The number of consecutive resource blocks N_{RB}^{CORESET} can be less than ten.

The configuration values can include a number of consecutive symbols N_{symb}^{CORESET}. The number of consecutive symbols N_{symb}^{CORESET} can be configured to be greater than three. Alternatively, the number of consecutive symbols N_{symb}^{CORESET} can be configured to be less than or equal to three, or either value.

The configuration values can include a number of repetitions R. The number of repetitions R can be any appropriate value, e.g., as described above with reference to examples 1 and 2, or 3, or both.

The pairs of configuration values for the number of consecutive resource blocks N_{RB}^{CORESET} and the number of consecutive symbols N_{symb}^{CORESET} can have any appropriate combination. For instance, the eCORESET, e.g., eCORESET #0, can have (N_{RB}^{CORESET}, N_{symb}^{CORESET})={8,3} and R=2; or (N_{RB}^{CORESET}, N_{symb}^{CORESET})={8,3} and R=4. In some examples, the eCORESET can have either of these values along with one or more other features from examples 1 and 2 described above.

In some implementations, the eCORESET, e.g., eCORESET #0, can have (N_{RB}^{CORESET}, N_{symb}^{CORESET})={8,6} and R=1; (N_{RB}^{CORESET}, N_{symb}^{CORESET})={4,12} and R=1; (N_{RB}^{CORESET}, N_{symb}^{CORESET})={8,12} and R=1; or (N_{RB}^{CORESET}, N_{symb}^{CORESET})={6,12} and R=2. The eCORESET can have any of these values along with one or more other features from example 3 described above.

A device can indicate or determine the CORESET configuration values using one or more bits from a master information block (“MIB”), one or more bits from a physical broadcast channel (“PBCH”), or a combination of both. For instance, the bits can include an information element (“IE”) from an MIB, e.g., a one-bit ‘Spare’ IE. The bits can include data from a PBCH payload, e.g., <a_{A+6}, a_{A+7}>. When it comprises three bits, the 3-bit field can indicate eight combinations of configuration values.

Table 3, below, provides one exemplified eCORESET #0 configuration table. The offset parameter is described in more detail below, e.g., with reference to example 4. In Table 3, two offsets values can be supported for eCORESET #0 configuration and four different combinations of <Number of resource blocks, Number of symbols, Repetition Number>. In Table 3, the least significant bit of the index value in the table can be the MIB bit, e.g., a one-bit ‘Spare’ IE. In Table 3, the most significant bits of the index value can be the bits from the PBCH payload, e.g., <a_{A+6}, a_{A+7}>. For an example of an index value of ‘110’, the MIB bit can be equal to ‘0” and the PBCH payload bits can be equal to <1,1>. The corresponding row in the table can be for index-6, e.g., <6, 12, 2, 01>. In some examples, the configuration table does not include the offset.

TABLE 3
eCORESET configuration values

| | Number of | Number of | Repetition | |
|---|---|---|---|---|
| Index | resource blocks | symbols | number | Offset |
| 0 | 8 | 6 | 1 | O₁ |
| 1 | 8 | 6 | 1 | O₂ |
| 2 | 4 | 12 | 1 | O₁ |
| 3 | 4 | 12 | 1 | O₂ |
| 4 | 8 | 12 | 1 | O₁ |
| 5 | 8 | 12 | 1 | O₂ |
| 6 | 6 | 12 | 2 | O₁ |
| 7 | 6 | 12 | 2 | O₂ |

In legacy operations (e.g., Release 15), an offset value for the CORESET #0 may be defined from the smallest resource block index of the CORESET for Type0-PDCCH CSS set to the smallest resource block index of the common resource block overlapping with the first resource block of the corresponding an synchronization signal/physical broadcast channel (“SSB”) block, which was signaled by the PBCH IE ‘subCarrierSpacingCommon’. However, this offset value does not indicate a frequency-domain location of an eCORESET #0 by a shared PBCH channel.

Example 4 includes receiving an index that indicates a frequency-domain location of an enhanced control resource set (CORESET); determining, using the index, an offset value for the frequency-domain location of the enhanced control resource set; and determining, using the offset value, the frequency-domain location of the enhanced control resource set in the frequency-domain.

For example, an offset parameter, e.g., an index, can indicate a location, e.g., in a frequency-domain, of an eCORESET #0 by a shared PBCH. The offset parameter can be defined from the smallest resource block index of the eCORESET #0 to the smallest resource block index of the common resource block overlapping with a reference. The reference can be the smallest resource block or the largest resource block of the corresponding PBCH. The reference can be the smallest resource block or the largest resource block of a corresponding legacy CORESET, e.g., that is used by non-eRedCap user equipment.

The offset parameter can have any appropriate value. For instance, a set of offset values {O₁, O₂, . . . , O_{N}} can be predefined, e.g., hard-encoded in a 3GPP specification. In some examples, a field in a PBCH, an MIB, or a combination of both, can be used to signal the offset value, e.g., row index and the associated parameters. For instance, the field can include an information element (“IE”) from an MIB, e.g., a one-bit ‘Spare’ IE. The field can include data from a PBCH payload, e.g., <a_{A+6}, a_{A+7>.}

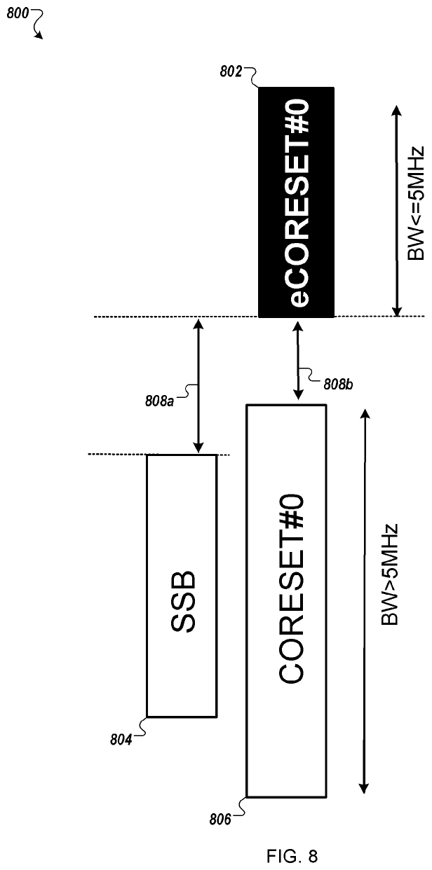

FIG. 8 depicts an example environment 800 in which an eCORESET 802 is offset from a reference 804-6. The reference can be any appropriate reference. For instance, the reference can be with respect to an SSB 804 (i.e., the PBCH of the SSB) or a legacy CORESET #0 806. As shown in FIG. 8, the eCORESET 802 is communicated using a bandwidth frequency less than or equal to 5 MHz. The legacy CORESET #0 is communicated using a bandwidth frequency greater than 5 MHz.

In the environment 800, the offset parameter 808a-b can be from the smallest resource block index of the eCORESET #0 to the smallest resource block index of the common resource block overlapping with largest resource block of the corresponding PBCH or CORESET #0 for legacy UEs.

The SSB can be shared for both eRedCap and non-eRedCap user equipment, e.g., RedCap or non-RedCap user equipment. This can minimize the signaling overhead.

In some implementations, as part of a random access procedure, a device can transmit a preamble on physical random access channel (“PRACH”), Message 3 on a physical uplink shared channel (“PUSCH”), Message 2/4 on physical downlink shared channel (“PDSCH”), and corresponding signaling, e.g. grants, HARQ-ACK.

New Radio defines two kinds of PRACH preambles, e.g., short preambles and long preambles. The short and long preambles can differ in lengths and numerologies. Long preambles can have two numerologies, e.g., 1.25 kHz and 5 kHz subcarrier spacing, and can only be used in FR1. For short preambles, 15 kHz or 30 kHz subcarrier spacing is used for FR1.

However, a short preamble typically occupies 12 RBs in the frequency domain regardless of the preamble numerology. Therefore, the PRACH bandwidth for both the short and long preambles for FR1 exceeds the 5 MHz bandwidth for eRedCap devices when 30 kHz SCS is used, which is limited to 11 PRBs (see Table 1 above).

In 3GPP Release 16, a device, e.g., with at least 20 MHz BW, can use up to eight random access channel (“RACH”) occasions (“RO”) frequency division multiplexed (“FDMed”) in a RACH slot. However, since an eRedCap UE is limited to a frequency bandwidth of 5 MHz or less, an eRedCap UE cannot send up to eight ROs FDMed in a RACH slot as required for SSB transmission.

Example 5 includes identifying two or more physical random access channel (“PRACH”) occasions according to an association pattern period that comprises one of i) at least 32 physical random access channel association periods for a configuration period of 10 milliseconds, ii) at least 16 physical random access channel association periods for a configuration period of 20 milliseconds, iii) at least 8 physical random access channel association periods for a configuration period of 40 milliseconds, iv) at least 4 physical random access channel association periods for a configuration period of 80 milliseconds, or v) at least 2 physical random access channel association periods for a configuration period of 160 milliseconds; and transmitting a PRACH message according to the two or more physical random access channel occasions.

Since an eRedCap user equipment with a maximum of 5 MHz bandwidth can only support at most two FDMed ROs in a RACH slot for 15 kHz SCS and one RO in a RACH slot for 30 kHz SCS, various solutions discussed herein can allow an eRedCap UE to still use a sufficient number of ROs (e.g., up to eight ROs) for sufficient opportunity for random access transmissions.

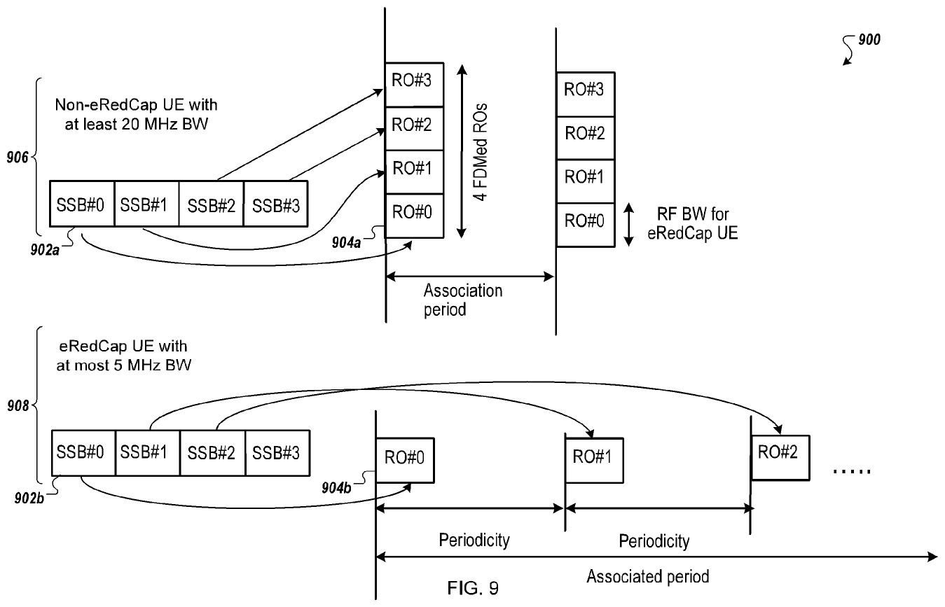

FIG. 9 depicts an example of an environment 900 with two different association periods. As shown in the environment 900, the number of transmitted SSBs indicated to UE is N_{Tx}^{SSB}=4. In the environment 900, each SSB 902a-b is mapped to a single RO 904a-b.

For a legacy RACH occasion association period for a non-eRedCap user equipment 906, the number of FDMed ROs 904a may be four, as illustrated in the example. Since an eRedCap UE 908 can only support at most two FDMed ROs, the eRedCap UE 908 would be unable to support the legacy RACH occasion association period.

To address this, the eRedCap UE 908 can use an association period with a single RO in a RACH slot as shown in FIG. 9, e.g., assuming 30 kHz SCS. For instance, the number of time-domain RO 904b in one PRACH slot is one, e.g., PRACH format B4 to ensure the coverage.

The number of PRACH slots in one periodicity is one. This can enable the eRedCap UE 908 to have a similar number of RACH occasions as the non-eRedCap UE 906 even though the eRedCap UE 908 is limited to a maximum of 5 MHz.

When the eRedCap UE 908 uses a 15 kHz SCS, the eRedCap UE 908 can have an association period with two FDMed ROs in a RACH slot. Since a longer association period increases latency, the use of two FDMed ROs for 15 kHz SCS has an improved latency compared to one RO for 30 kHz SCS, e.g., but still has an increased latency compared to the legacy RACH occasion association period.

Table 4, below, shows an example mapping between PRACH configuration period and SSB to PRACH occasion association period for an eRedCap user equipment (“UE”). Since an association period indicates a minimum number of PRACH configuration periods that include sufficient ROs to allow every SSB beam to be mapped to a set of ROs at least once, and an eRedCap UE supports fewer FDMed ROs than non-eRedCap UEs, the eRedCap UE requires a larger association period, e.g., a greater number of PRACH configuration periods. As shown in Table 4, an eRedCap UE can have up to eight association periods depending on the PRACH configuration period used. To support the eRedCap UE, Table 4 includes three additional potential association periods for each PRACH configuration period.

TABLE 4
Mapping between PRACH configuration period and SSB
to PRACH occasion association period for eRedCap UE

| PRACH configuration | Association period (number of |
|---|---|
| period (msec) | PRACH configuration periods) |
| 10 | {1, 2, 4, 8, 16, 32, 64, 128} |
| 20 | {1, 2, 4, 8, 16, 32, 64} |
| 40 | {1, 2, 4, 8, 16, 32} |
| 80 | {1, 2, 4, 8, 16} |
| 160 | {1, 2, 4, 8} |

Example 6 includes identifying, in a half-frame, two or more physical random access channel (“PRACH”) occasions in corresponding subframes, which subframes are separated in time; and transmitting a PRACH message according to the two or more physical random access channel occasions.

In some implementations, to enable an eRedCap device to use short and long preambles with 30 kHz SCS, a device can use more RACH slots in a PRACH time-domain pattern. For instance, the device can add one or more shifted RACH subframes in addition to the subframes included in an existing RACH slot pattern. This can enable an eRedCap device to identify multiple ROs within a RACH subframe, without the increased latency caused by a longer association period, e.g., as described above with reference to example 5. For instance, instead of having a longer association period that results in an increased latency, a device, e.g., a base station, can designate additional subframes within a frame in the time domain. The eRedCap device can then identify the ROs in the additional subframes and transmit a PRACH message according to the ROs.

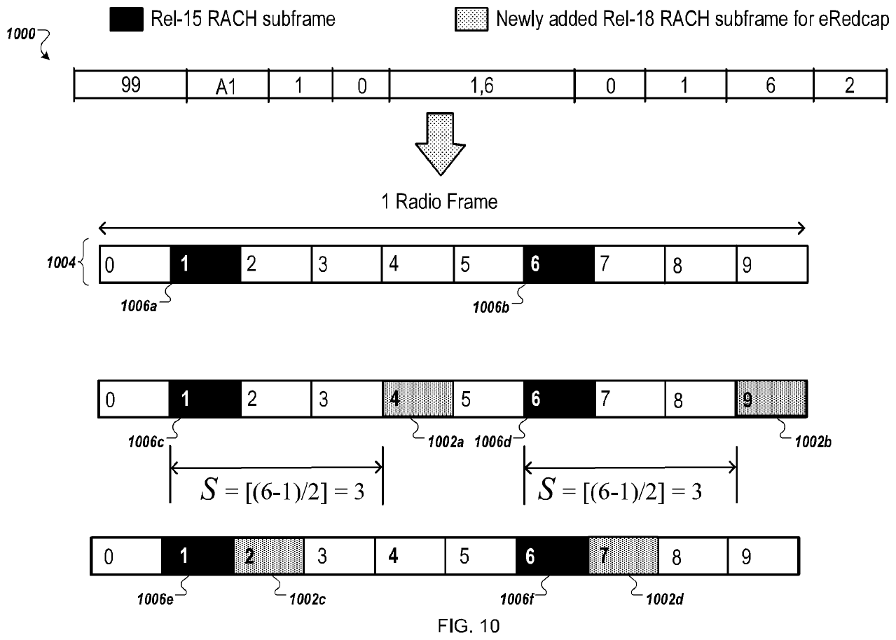

FIG. 10 depicts an example environment 1000 that includes one or more additional RACH subframes 1002a-d. In the environment 1000, an existing RACH slot pattern 1004 includes two subframes 1006a-b.

In some examples, a device can use the one or more shifted RACH subframes 1002a-b, represented by the shifting slot by ‘S’, relative to the existing RACH slot pattern 1004. The device can use any appropriate process to determine, signal, or both, the value of the shifting slot ‘S’.

For instance, the device can determine the value of the shifting slot S can be determined using S=┌(S2−S1)/L┐ mod 10, where S1, S2 are two consecutive subframe indices of PRACH slot 1006c-d for a given configuration. ‘L’ denotes the number of newly added RACH subframes between two existing RACH subframes, e.g., two as shown in the environment 900.

In some implementations, a device can use one or more consecutive RACH subframes 1002c-d in a frame, a subframe, or both. The newly added subframe(s) 1002c-d can consecutive subframe(s) that are each larger than the existing PRACH subframe index used by non-eRedCap devices. Although the existing PRACH subframe index is varied and configured by RRC signaling, the newly added subframes are larger than the existing subframe index when other factors are the same except that the newly added subframes are for eRedCap devices while the existing subframe index is for non-eRedCap devices.

The number of newly added RACH subframes ‘L’ is be any appropriate value. For instance, the number of newly added RACH subframes L can be predetermined, e.g., hard-encoded in a 3GPP specification. In some examples, a device, e.g., base station, can indicate the number of newly added RACH subframes L in a system information block, e.g., SIB1. The device can add a new information element for PRACH configuration for eRedCap UEs to the system information block. In some implementations, the number of newly added RACH subframes L is two.

In the environment 1000, the one or more consecutive RACH subframes 1002c-d, that follow the RACH subframes 1006e-f, are based on a PRACH numerology of 15 kHz SCS, a PRACH configuration index of 99, and a number of newly added subframes of L=2.

Example 7 may include one or more non-transitory computer-readable media comprising instructions to cause an electronic device, upon execution of the instructions by one or more processors of the electronic device, to perform one or more elements of a method described in or related to any of examples 1-6, or any other method or process described herein.

Example 8 may include an apparatus comprising logic, modules, or circuitry to perform one or more elements of a method described in or related to any of examples 1-6, or any other method or process described herein.

Example 9 may include a method, technique, or process as described in or related to any of examples 1-6, or portions or parts thereof.

Example 10 may include an apparatus comprising: one or more processors and one or more computer-readable media comprising instructions that, when executed by the one or more processors, cause the one or more processors to perform the method, techniques, or process as described in or related to any of examples 1-6, or portions thereof.

Example 11 may include a signal as described in or related to any of examples 1-6, or portions or parts thereof.

Example 12 may include a datagram, information element, packet, frame, segment, PDU, or message as described in or related to any of examples 1-6, or portions or parts thereof, or otherwise described in the present disclosure.

Example 13 may include a signal encoded with data as described in or related to any of examples 1-6, or portions or parts thereof, or otherwise described in the present disclosure.

Example 14 may include a signal encoded with a datagram, IE, packet, frame, segment, PDU, or message as described in or related to any of examples 1-6, or portions or parts thereof, or otherwise described in the present disclosure.

Example 15 may include an electromagnetic signal carrying computer-readable instructions, wherein execution of the computer-readable instructions by one or more processors is to cause the one or more processors to perform the method, techniques, or process as described in or related to any of examples 1-6, or portions thereof.

Example 16 may include a computer program comprising instructions, wherein execution of the program by a processing element is to cause the processing element to carry out the method, techniques, or process as described in or related to any of examples 1-6, or portions thereof.

Example 17 may include a signal in a wireless network as shown and described herein.

Example 18 may include a method of communicating in a wireless network as shown and described herein.

Example 19 may include a system for providing wireless communication as shown and described herein. The operations or actions performed by the system can include the methods of any one of examples 1-6.

Example 20 may include a device for providing wireless communication as shown and described herein. The operations or actions performed by the device can include the methods of any one of examples 1-6.

The previously-described examples 1-6 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus comprising one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-6.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

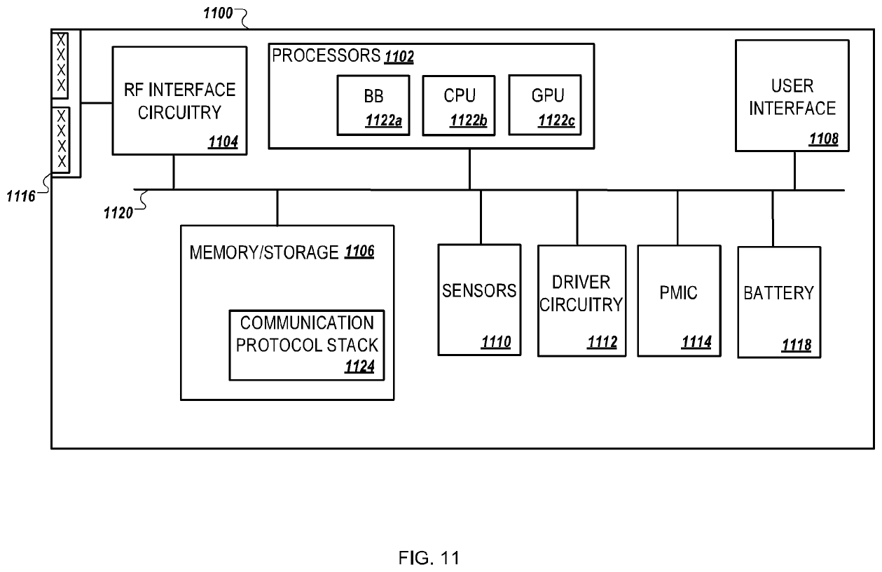

FIG. 11 illustrates a UE 1100, in accordance with some embodiments. The UE 1100 may be similar to and substantially interchangeable with UE 102 of FIG. 1.

The UE 1100 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1100 may include processors 1102, RF interface circuitry 1104, memory/storage 1106, user interface 1108, sensors 1110, driver circuitry 1112, power management integrated circuit (PMIC) 1114, antenna structure 1116, and battery 1118. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1120, which may represent any type of interface, input/output, bus (local, system, or expansion), transmission line, trace, optical connection, etc. that allows various circuit components (on common or different chips or chipsets) to interact with one another.

The processors 1102 may include processor circuitry such as, for example, baseband processor circuitry (BB) 1122A, central processor unit circuitry (CPU) 1122B, and graphics processor unit circuitry (GPU) 1122C. The processors 1102 may include any type of circuitry or processor circuitry that executes or otherwise operates computer-executable instructions, such as program code, software modules, or functional processes from memory/storage 1106 to cause the UE 1100 to perform operations as described herein.

In some embodiments, the baseband processor circuitry 1122A may access a communication protocol stack 1124 in the memory/storage 1106 to communicate over a 3GPP compatible network. In general, the baseband processor circuitry 1122A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1104. The baseband processor circuitry 1122A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 1106 may include one or more non-transitory, computer-readable media that includes instructions (for example, communication protocol stack 1124) that may be executed by one or more of the processors 1102 to cause the UE 1100 to perform various operations described herein. The memory/storage 1106 include any type of volatile or non-volatile memory that may be distributed throughout the UE 1100. In some embodiments, some of the memory/storage 1106 may be located on the processors 1102 themselves (for example, L1 and L2 cache), while other memory/storage 1106 is external to the processors 1102 but accessible thereto via a memory interface. The memory/storage 1106 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1104 may include transceiver circuitry and radio frequency front module (RFEM) that allows the UE 1100 to communicate with other devices over a radio access network. The RF interface circuitry 1104 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1116 and proceed to filter and amplify (with a low-noise amplifier) the signal. The signal may be provided to a receiver of the transceiver that downconverts the RF signal into a baseband signal that is provided to the baseband processor of the processors 1102.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1116.

In various embodiments, the RF interface circuitry 1104 may be configured to transmit/receive signals in a manner compatible with NR access technologies.

The antenna 1116 may include antenna elements to convert electrical signals into radio waves to travel through the air and to convert received radio waves into electrical signals. The antenna elements may be arranged into one or more antenna panels. The antenna 1116 may have antenna panels that are omnidirectional, directional, or a combination thereof to enable beamforming and multiple input, multiple output communications. The antenna 1116 may include microstrip antennas, printed antennas fabricated on the surface of one or more printed circuit boards, patch antennas, phased array antennas, etc. The antenna 1116 may have one or more panels designed for specific frequency bands including bands in FR1 or FR2.

The user interface 1108 includes various input/output (I/O) devices designed to enable user interaction with the UE 1100. The user interface 1108 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1100.

The sensors 1110 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1112 may include software and hardware elements that operate to control particular devices that are embedded in the UE 1100, attached to the UE 1100, or otherwise communicatively coupled with the UE 1100. The driver circuitry 1112 may include individual drivers allowing other components to interact with or control various input/output (I/O) devices that may be present within, or connected to, the UE 1100. For example, driver circuitry 1112 may include a display driver to control and allow access to a display device, a touchscreen driver to control and allow access to a touchscreen interface, sensor drivers to obtain sensor readings of sensor circuitry 1128 and control and allow access to sensor circuitry 1128, drivers to obtain actuator positions of electro-mechanic components or control and allow access to the electro-mechanic components, a camera driver to control and allow access to an embedded image capture device, audio drivers to control and allow access to one or more audio devices.

The PMIC 1114 may manage power provided to various components of the UE 1100. In particular, with respect to the processors 1102, the PMIC 1114 may control power-source selection, voltage scaling, battery charging, or DC-to-DC conversion.

In some embodiments, the PMIC 1114 may control, or otherwise be part of, various power saving mechanisms of the UE 1100 including DRX as discussed herein. A battery 1118 may power the UE 1100, although in some examples the UE 1100 may be mounted deployed in a fixed location, and may have a power supply coupled to an electrical grid. The battery 1118 may be a lithium ion battery, a metal-air battery, such as a zinc-air battery, an aluminum-air battery, a lithium-air battery, and the like. In some implementations, such as in vehicle-based applications, the battery 1118 may be a typical lead-acid automotive battery.

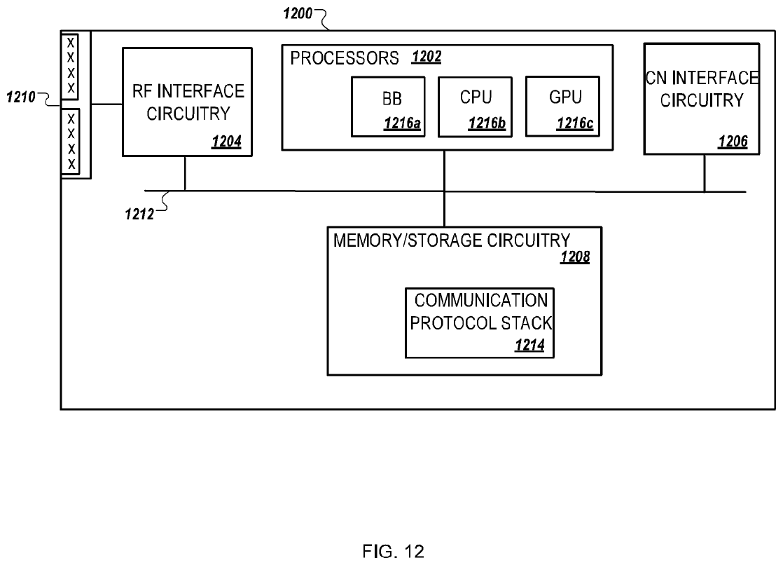

FIG. 12 illustrates an access node 1200 (e.g., a base station or gNB), in accordance with some embodiments. The access node 1200 may be similar to and substantially interchangeable with base station 104. The access node 1200 may include processors 1202, RF interface circuitry 1204, core network (CN) interface circuitry 1206, memory/storage circuitry 1208, and antenna structure 1210.

The components of the access node 1200 may be coupled with various other components over one or more interconnects 1212. The processors 1202, RF interface circuitry 1204, memory/storage circuitry 1208 (including communication protocol stack 1214), antenna structure 1210, and interconnects 1212 may be similar to like-named elements shown and described with respect to FIG. 11. For example, the processors 1202 may include processor circuitry such as, for example, baseband processor circuitry (BB) 1216A, central processor unit circuitry (CPU) 1216B, and graphics processor unit circuitry (GPU) 1216C.

The CN interface circuitry 1206 may provide connectivity to a core network, for example, a 5th Generation Core network (5GC) using a 5GC-compatible network interface protocol such as carrier Ethernet protocols, or some other suitable protocol. Network connectivity may be provided to/from the access node 1200 via a fiber optic or wireless backhaul. The CN interface circuitry 1206 may include one or more dedicated processors or FPGAs to communicate using one or more of the aforementioned protocols. In some implementations, the CN interface circuitry 1206 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to an access node 1200 that operates in an NR or 5G system (for example, a gNB), and the term “E-UTRAN node” or the like may refer to an access node 1200 that operates in an LTE or 4G system (e.g., an eNB). According to various embodiments, the access node 1200 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 1200 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 1200; a MAC/PHY split wherein RRC, PDCP, RLC, and MAC layers are operated by the CRAN/vBBUP and the PHY layer is operated by the access node 1200; or a “lower PHY” split wherein RRC, PDCP, RLC, MAC layers and upper portions of the PHY layer are operated by the CRAN/vBBUP and lower portions of the PHY layer are operated by the access node 1200.

In V2X scenarios, the access node 1200 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth in the example section, the summary, or both.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
identifying one or more instances of a control resource set (“CORESET”);
monitoring a physical downlink control channel (“PDCCH”) candidate to detect a physical downlink control channel using the one or more instances of the CORESET; and
receiving, based on the detected PDCCH, data scheduled by the PDCCH.

2. The method of claim 1, wherein:
identifying the one or more instances of the CORESET comprises:
identifying a first instance of the CORESET with a first mapping of a control channel element (“CCE”) to a resource element group (“REG”) mapping configured by Radio Resource Control (“RRC”) signaling; and
identifying a second different instance of the CORESET with a second mapping of a CCE-to-REG mapping configured by RRC signaling; and
monitoring the PDCCH candidate comprises monitoring the PDCCH candidate using a union of the first instance and the second different instance of the CORESET.

3. The method of claim 1, wherein identifying the one or more instances of the CORESET comprises identifying one or more intra-slot instances of the CORESET that are configured by RRC signaling.

4. The method of claim 1, wherein identifying the one or more instances of the CORESET comprises identifying one or more inter-slot instances of the CORESET that are configured by RRC signaling.

5. The method of claim 1, comprising:
receiving a value K of offset parameter that is configured for a first instance of the CORESET by Radio Resource Control (RRC) signaling; and
determining a first symbol of a second instance of the CORESET after K symbols from a last symbol of the first instance, wherein the one or more instances of the CORESET comprise two or more instances of the CORESET including the first instance and the second instance.

6. The method of claim 1, comprising:
receiving a value K of offset parameter that is configured for a first instance of the CORESET by Radio Resource Control (RRC) signaling; and
determining a first symbol of a second instance of the CORESET after K slots from a first symbol of the first instance, wherein the one or more instances of the CORESET comprise two or more instances of the CORESET including the first instance and the second instance.

7. The method of claim 1, wherein the CORESET comprises a number of consecutive resource blocks (RBs) in frequency domain that is less than ten.

8. The method of claim 1, wherein the CORESET comprises a number of consecutive symbols that is greater than three.

9. The method of claim 1, wherein a CORESET configuration comprises a set of parameters that includes:
a number of consecutive resource blocks (“RBs”);
a number of consecutive symbols; and
a number of repetitions.

10. The method of claim 9, further comprising:
the number of RBs is 8;
the number of consecutive symbols is selected from a group comprising 3, 6 or 12; and
the number of repetitions is 2 or 4.

11. The method of claim 1, comprising determining one or more configuration values for the control resource set using a master information block, a physical broadcast channel, or both.

12. A method comprising:
determining, by a first device, that a second device with which the first device will communicate is an enhanced-reduced capability device;
in response to determining that the second device is an enhanced-reduced capability device, selecting a physical downlink control channel for the communication with the enhanced-reduced capability device;
determining a control resource set that is used for the physical downlink control channel communication;
configuring one or more instances of the control resource set; and
transmitting, using the control resource set, the physical downlink control channel.

13. The method of claim 12, comprising determining a number of repetitions of the control resource set to send.

14. The method of claim 13, wherein determining the number of repetitions comprises determining a fixed number of repetitions of the control resource set to send.

15. The method of claim 13, wherein determining the number of repetitions comprises determining, using a radio resource control signal, the number of repetitions of the control resource set to send.

16. The method of claim 12, comprising signaling one or more configuration values for the control resource set using a master information block, a physical broadcast channel, or both.

17. The method of claim 16, wherein signaling the one or more configuration values comprises signaling the one or more configuration values using an information element from the master information block, at least one bit from a payload of the physical broadcast channel, or both.

18. The method of claim 16, wherein signaling the one or more configuration values for control resource set comprises signaling one or more of a number of consecutive resource blocks, a number of consecutive symbols, or a number of instances of the control resource set.

19-20. (canceled)

21. A processor configured to, when executing instructions stored in a memory, perform operations comprising:
identifying one or more instances of a control resource set (“CORESET”);
monitoring a physical downlink control channel (“PDCCH”) candidate to detect a physical downlink control channel using the one or more instances of the CORESET; and
receiving, based on the detected PDCCH, data scheduled by the PDCCH.

22. The processor of claim 21, wherein:
identifying the one or more instances of the CORESET comprises:
identifying a first instance of the CORESET with a first mapping of a control channel element (“CCE”) to a resource element group (“REG”) mapping configured by Radio Resource Control (“RRC”) signaling; and
identifying a second different instance of the CORESET with a second mapping of a CCE-to-REG mapping configured by RRC signaling; and
monitoring the PDCCH candidate comprises monitoring the PDCCH candidate using a union of the first instance and the second different instance of the CORESET.
